(19) United States
(12) Patent Application Publication
(10) Pub. No.: US 2023/0281491 A1
(43) Pub. Date: Sep. 7, 2023

(54) SYSTEM AND METHOD ENABLING ACCELERATED DEVELOPMENT AND APPLICATION OF AUTONOMOUS ECONOMIC AGENTS

(71) Applicant: Uvue Ltd., Bury St Edmunds (GB)

(72) Inventors: Ali Hosseini, Bury St Edmunds (GB); Humayun Munir Sheikh, Bury St Edmunds (GB)

(21) Appl. No.: 18/180,896

(22) Filed: Mar. 9, 2023

Related U.S. Application Data
(63) Continuation-in-part of application No. 17/234,932, filed on Apr. 20, 2021.
Application No. 17/234,932 is a continuation-in-part of application No. 16/130,218, filed on Sep. 13, 2018, now abandoned.

(51) Int. Cl. G06N 5/043

(52) U.S. Cl. CPC G06N 5/043

(57) ABSTRACT

Disclosed is a system that, in operation, enables accelerated development and application of autonomous economic agents (AEAs), that are modular and extensible, across a plurality of problem domains. The system comprises decentralized computing network that is configured to implement a software framework, software framework includes domain-independent protocol specification language, protocol generator and at least one software module. The at least one software module is configured to: receive, from given AEA, invocation of protocol generator for protocol specification; execute protocol generator to produce implementation of at least one protocol corresponding to protocol specification, for given AEA, using domain-independent protocol specification language, by taking into account technological setup of given AEA; and combine at least one of: one or more protocols, one or more skills, one or more connections supported by at least one AEA, in plurality of manners, to create plurality of AEA-based functionalities for given AEA across plurality of problem domains.

### CROSS-REFERENCE TO RELATED APPLICATIONS

This application is a continuation-in-part of U.S. patent application Ser. No. U.S. Ser. No. 17/234,932, titled “DISTRIBUTED COMPUTER SYSTEM FOR MANAGEMENT OF SERVICE REQUEST AND METHOD OF OPERATION THEREOF” and filed on Apr. 20, 2021, which is incorporated herein by reference.

### TECHNICAL FIELD

The present disclosure relates generally to systems that, in operation, enable accelerated development and application of autonomous economic agents (AEAs), that are modular and extensible, across a plurality of problem domains. The present disclosure also relates to methods for accelerated development and application of autonomous economic agents (AEAs), that are modular and extensible, across a plurality of problem domains.

### BACKGROUND

The advancement of technology has made daily activities like cleaning, shopping, and communication easier, but procuring these services still requires significant time and effort. To address this, service providers and intermediaries have emerged to assist users in obtaining the services they need. However, the use of intermediaries and service providers also comes with the risk of a failed service and potential loss of payment.

In recent years, though the development of AEAs has advanced significantly, in order to ensure a successful interaction in a mixed cooperative and adversarial environment, well-defined protocols for autonomous economic agents (AEAs) are necessary. Although there are several existing protocol languages for multi-agent systems, they are either purely theoretical or have limited implementations, which are primarily for academic and research purposes. Typically, protocols for interactions of the AEAs are defined in a manner that the AEAs are able to interact only in certain domain(s). Furthermore, enabling such AEAs to interact in other domains is either infeasible, or is extremely complex and challenging. Additionally, there exists several problems associated with producing protocols implementations specific to a technological setup of the AEAs and expanding the AEA network for enhanced applications thereof. In an example, the problem could be a high computational cost that is involved with having different technology setups for different AEAs, when the different AEAs require different protocol specifications based on an application thereof. Moreover, there exist several challenges that occur when existing AEAs interact in the environment. In this regard, these challenges include a higher risk of security breaches, such as hacking or theft of assets. Currently, different AEAs may have been developed using different technologies and programming languages, leading to interoperability issues during interaction thereof. Furthermore, as the number of AEAs grows in the environment, the complexity of interactions increases, leading to scalability challenges. Additionally, the design of AEAs and their interaction protocols is quite customized presently, leading to difficulties in achieving interoperability, accelerated development of solutions, and consistency in their interactions.

Therefore, in light of the foregoing technical problems, there exists a need to overcome the aforementioned problems associated with existing AEAs.

### SUMMARY

The present disclosure seeks to provide a system that, in operation, enables accelerated development and application of autonomous economic agents (AEAs), that are modular and extensible, across a plurality of problem domains. The present disclosure also seeks to provide a method for accelerated development and application of autonomous economic agents (AEAs), that are modular and extensible, across a plurality of problem domains. An aim of the present disclosure is to provide a solution that overcomes at least partially the problems encountered in prior art.

In one aspect, there is provided a system that, in operation, enables accelerated development and application of autonomous economic agents (AEAs), that are modular and extensible, across a plurality of problem domains, the system comprising a decentralized computing network that is configured to implement a software framework, wherein the software framework includes a domain-independent protocol specification language, a protocol generator, and at least one software module, and wherein:
the at least one software module is configured to receive, from a given AEA, an invocation of the protocol generator for a protocol specification;
the at least one software module is configured to execute the protocol generator to produce an implementation of at least one protocol corresponding to the protocol specification, for the given AEA, using the domain-independent protocol specification language, and by taking into account a technological setup of the given AEA; and
the at least one software module is configured to combine at least one of: one or more protocols for at least one AEA, one or more skills of at least one AEA, one or more connections supported by at least one AEA, in a plurality of manners, to create a plurality of AEA-based functionalities for the given AEA across the plurality of problem domains.

Optionally, the decentralized computing network comprises a plurality of computing devices that are communicably coupled to each other, and wherein each of the plurality of computing devices comprises at least one processor, at least one memory device, and a communication interface.

Optionally, the domain-independent protocol specification language is stored in a form of a set of instructions, in at least one memory device of the decentralized computing network.

Optionally, the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on.

Optionally, the implementation of the at least one protocol for the given AEA is produced as a protocol package comprising a logic associated with the protocol specification and a validation check on syntax and semantics of at least one service request message that is sent and/or received by the given AEA.

Optionally, when combining the one or more protocols for the at least one AEA, the one or more skills of the at least one AEA, and the one or more connections supported by the at least one AEA in the plurality of manners, for each manner of combination amongst the plurality of manners, the at least one software module in operation adds a logic that is exclusive to the manner of combination.

Optionally, the at least one software module in operation further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

Optionally, the software framework is associated with a plurality of AEAs which are communicably interconnected using the decentralized computing network, and wherein the plurality of AEAs serve as a plurality of worker nodes of the decentralized computing network, for collectively fulfilling service requests belonging to the plurality of problem domains.

Optionally, the at least one protocol implemented by the protocol generator enables the given AEA to interact in mixed cooperative and adversarial environments, across the plurality of problem domains.

Optionally, the implementation of the at least one protocol for the given AEA defines at least one dialogue-based bilateral interaction protocol supporting arbitrary agent-based interactions of the given AEA.

In another aspect, the present disclosure further provides a method for accelerated development and application of autonomous economic agents (AEAs), that are modular and extensible, across a plurality of problem domains, the method comprising a software framework using a decentralized computing network, wherein the software framework includes a domain-independent protocol specification language, a protocol generator and at least one software module, and wherein the at least one software module of the software framework in operation, performs steps of:
receiving, from a given AEA, an invocation of a protocol generator for a protocol specification;
executing the protocol generator for producing an implementation of at least one protocol corresponding to the protocol specification, for the given AEA, using the domain-independent protocol specification language, and by taking into account the technological setup of the given AEA; and
combining one or more protocols for at least one AEA, one or more skills of at least one AEA, and one or more connections supported by at least one AEA in a plurality of manners to create a plurality of AEA-based functionalities for the given AEA across the plurality of problem domains.

Optionally, the decentralized computing network comprises a plurality of computing devices that are communicably coupled to each other, and wherein each of the plurality of computing devices comprises at least one processor, at least one memory device, and a communication interface.

Optionally, the method further comprises storing the domain-independent protocol specification language in a form of a set of instructions, in at least one memory device of the decentralized computing network.

Optionally, the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on.

Optionally, the implementation of the at least one protocol for the given AEA is produced as a protocol package comprising a logic associated with the protocol specification and a validation check on syntax and semantics of at least one service request message that is sent and/or received by the given AEA.

Optionally, the step of combining the one or more protocols for the at least one AEA, the one or more skills of the at least one AEA, and the one or more connections supported by the at least one AEA in the plurality of manners comprises, for each manner of combination amongst the plurality of manners, adding a logic that is exclusive to the manner of combination.

Optionally, the at least one software module in operation, further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

Optionally, the software framework is associated with a plurality of AEAs which are communicably interconnected using the decentralized computing network, and wherein the plurality of AEAs serve as a plurality of worker nodes of the decentralized computing network, for collectively fulfilling service requests belonging to the plurality of problem domains.

Optionally, the at least one protocol implemented by the protocol generator enables the given AEA to interact in mixed cooperative and adversarial environments, across the plurality of problem domains.

Optionally, the implementation of the at least one protocol for the given AEA defines at least one dialogue-based bilateral interaction protocol supporting arbitrary agent-based interactions of the given AEA.

Embodiments of the present disclosure substantially eliminate or at least partially address the aforementioned problems in the prior art, and enable an implementation of at least one protocol corresponding to a protocol specification, for a given autonomous economic agent (AEA), thus allowing interactions of a plurality of AEAs across a multitude of problem domains. Additionally, the system enables reusability of the one or more protocols, one or more skills and one or more connections of the AEAs. Moreover, the reusability makes the development and expansion of the system's functionality time efficient. It will be appreciated that the concept of the protocol specification combined with multi-domain operability of AEAs enables an easier implementation of new functionalities of the AEAs.

Additional aspects, advantages, features and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a block diagram illustrating a system that, in operation, enables accelerated development and application of autonomous economic agents (AEAs), that are modular and extensible, across a plurality of problem domains, in accordance with an embodiment of the present disclosure;

FIG. 1B illustrates an architecture of a computing device of FIG. 1A, in accordance with an embodiment of the present disclosure;

FIG. 2 is a block diagram illustrating abstractions and modularity of a given AEA, in accordance with an embodiment of the present disclosure;

FIG. 3 is a block diagram illustrating an operation of a software framework such as an open economic framework (OEF) for providing a service to a plurality of computing devices, in accordance with an embodiment of the present disclosure; and

FIG. 4 is a flowchart depicting steps of a method for accelerated development and application of autonomous economic agents (AEAs), that are modular and extensible, across a plurality of problem domains, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, the present disclosure provides a system that, in operation, enables accelerated development and application of autonomous economic agents (AEAs), that are modular and extensible, across a plurality of problem domains, the system comprising a decentralized computing network that implements a software framework, wherein the software framework includes a domain-independent protocol specification language, a protocol generator, at least one software module, and, and wherein:
the at least one software module is configured to receive, from a given AEA, an invocation of the protocol generator for a protocol specification;
the at least one software module is configured to execute the protocol generator to produce an implementation of at least one protocol corresponding to the protocol specification, for the given AEA, using the domain-independent protocol specification language, and by taking into account a technological setup of the given AEA; and
the at least one software module is configured to combine at least one of: one or more protocols for at least one AEA, one or more skills of at least one AEA, one or more connections supported by at least one AEA, in a plurality of manners, to create a plurality of AEA-based functionalities for the given AEA across the plurality of problem domains.

In another aspect, the present disclosure further provides a method for accelerated development and application of autonomous economic agents (AEAs), that are modular and extensible, across a plurality of problem domains, the method comprising implementing a software framework using a decentralized computing network, wherein the software framework includes a domain-independent protocol specification language, a protocol generator, and at least one software module, and wherein the at least one software module of the software framework in operation, performs steps of:
receiving, from a given AEA, an invocation of a protocol generator for a protocol specification;
executing the protocol generator for producing an implementation of at least one protocol corresponding to the protocol specification, for the given AEA, using the domain-independent protocol specification language, and by taking into account the technological setup of the given AEA; and
combining one or more protocols for at least one AEA, one or more skills of at least one AEA, and one or more connections supported by at least one AEA in a plurality of manners to create a plurality of AEA-based functionalities for the given AEA across the plurality of problem domains.

Throughout the present disclosure the term “autonomous economic agents” (referred to herein later as “AEAs”) as used herein, relates to software modules that are configured to execute one or more tasks. Such tasks may include communication of the AEAs with each other, processing of information, and so forth. In an example, the AEAs are configured to employ artificial intelligence (AI) algorithms and machine learning for the execution of the one or more tasks.

It will be appreciated that the AEAs are modular and extensible, thus the AEAs are self-sufficient entities associated with the system that could function independently and could be adapted or modified as needed to fit various use cases/circumstances based on their own rules and objectives. The AEAs are modular, meaning that they are composed of separate parts or units that can be combined together in various manners to achieve a variety of functionalities. The AEAs are extensible, meaning that their existing functionalities are capable of being extended further by addition of newer modular parts or units. It will be appreciated that when multiple AEAs work collectively for an application (i.e., use case), different steps of the application are completed by different AEAs. The multiple AEAs work in consensus to collectively reach a final outcome for achieving a required functionality of said application. Additionally, the AEAs could be modulated to perform new tasks, respond to changing market conditions, or interact with new environment without disrupting the overall functioning thereof or the system it operates within. This ability to expand and adapt makes autonomous economic agents more versatile and sustainable, thereby resulting in accelerated development thereof across the plurality of problem domains, thereby making the autonomous economic agents future proof. Herein, the plurality of problem domains may include, but is not limited to, energy, finance, supply chain, governance, manufacturing, mobility, smart cities and internet of things (IoT) applications.

The system comprises the decentralized computing network that is configured to implement the software framework. Herein, the software framework encompasses any software abstraction which can have one or more software modules to provide generic and/or specific functionality(-ies). Optionally, the software framework is an agent framework (i.e., a framework that enables creation of application-specific AEAs), or an open economic framework (OEF) employing AEAs, and the like. In this regard, the software framework is a specific implementation of the decentralized computing network, designed for the purpose of development of the AEAs and for enabling the AEAs to interact and transact with each other. The software framework provides the infrastructure and resources for AEAs to communicate, negotiate, and exchange value in a secure and transparent manner. Optionally, the software framework could comprise a plurality of software modules. Either, a single software module or multiple software modules could implement the processing steps.

Herein, the open economic framework refers to a computing framework that enables execution of tasks associated with various AEAs within the OEF. Furthermore, the OEF is configured to provide various tools, security protocols, rules and suchlike for the execution of tasks including, but not limited to, communication, processing of information and so forth, between different AEAs associated with the OEF. Furthermore, the OEF enables the plurality of AEAs to search, discover, and interact with each other. Moreover, the OEF optionally also includes components such as a registry component and a search and discovery component. The registry component could be a database of the plurality of AEAs or the components of AEAs such as skills, protocols and connections. It will be appreciated that each AEA can provide one or more services. The search and discovery component is used to find out one or more AEAs that match the requested service by the plurality of computing devices. For example, the search and discovery component is accessed by AEAs to find other AEAs that offer some specific services.

Optionally, the decentralized computing network comprises a plurality of computing devices that are communicably coupled to each other, and wherein each of the plurality of computing devices comprises at least one processor, at least one memory device, and a communication interface. In this regard, when in operation, each of the plurality of computing devices can perform as either a client device or a service component. In this regard, the client device is any device that acts as a client for the system, and in particular for AEAs. Examples of the client device include an organization on cloud seeking a service, an end user with a phone seeking a service or a decentralized autonomous organization (DAO) seeking a service. Optionally, each of the plurality of computing devices can simultaneously perform as the client device and the service component. Furthermore, a computing device that performs as this service component enables the AEAs to respond to a service request. Furthermore, the decentralized computing network is optionally implemented as a decentralized structured P2P (peer-to-peer) network of devices; alternatively, multi-layer communication networks are employed, wherein communication devices are migrated between the layers depending upon their technical functionality, reliability, peer-review assessment and/or trustworthiness. Specifically, the decentralized structured P2P network represents a decentralized computing environment within a P2P network.

Moreover, the decentralized computing network includes wired and/or wireless communication arrangements (namely “communicating means”) comprising a software component, a hardware component, a network adapter component, or a combination thereof. Furthermore, the communication network may be an individual network, or a collection of individual networks, interconnected with each other and functioning as a single large network. Such individual networks may be wired, wireless, or a combination thereof. In an example, the communication network includes Bluetooth®, Internet of things (IoT), Visible Light Communication (VLC), Near Field Communication (NFC), Local Area Networks (LANs), Wide Area Networks (WANs), Metropolitan Area Networks (MANs), Wireless LANs (WLANs), Wireless WANs (WWANs), Wireless MANs (WMANs), the Internet, telecommunication networks, radio networks, and so forth.

Optionally, the software framework is associated with a plurality of AEAs which are communicably interconnected using the decentralized computing network, and wherein the plurality of AEAs serve as a plurality of worker nodes of the decentralized computing network, for collectively fulfilling a plurality of AEA-based functionalities belonging to the plurality of problem domains. The term “AEA-based functionalities” as used herein refers to one or more functionalities of the AEAs, that enable the AEAs to serve a service request. Such functionalities may be, enabling digital payments, generating product recommendations, resolving customer queries, and the like. In this regard, the plurality of AEAs uses the OEF for collectively fulfilling the service requests belonging to the plurality of problem domains. Optionally, the worker nodes include computing arrangements that are operable to respond to, and processes instructions and data therein. The computing arrangements may include, but are not limited to, a microprocessor, a microcontroller, a complex instruction set computing (CISC) microprocessor, a reduced instruction set (RISC) microprocessor, a very long instruction word (VLIW) microprocessor, an artificial intelligence (AI) computing engine based on hierarchical networks of variable-state machines, or any other type of processing circuit. Furthermore, the computing arrangements can be one or more individual processors, processing devices and various elements associated with a processing device that may be shared by other processing devices. Additionally, the computing arrangements are arranged in various architectures for responding to and processing the instructions that drive the system.

The computing arrangements are processing devices that operate automatically. In such regard, the computing arrangements may be equipped with artificial intelligence algorithms that are configured to respond to and to perform the instructions that drive the system based on data learning techniques. The computing arrangements devices are capable of automatically responding and of performing instructions based on input provided by the one or more users (namely, the worker nodes participating in the system). The worker nodes further include local databases to store data therein. Furthermore, the collective learning of the worker nodes is managed within the system. Notably, the computing model is trained between the plurality of worker nodes in a manner that the intermediary computing models that have been partially trained are shared between the worker nodes and resources of worker nodes are utilized productively.

Moreover, the plurality of worker nodes are communicably coupled to each other via the decentralized computing network. For example, the software framework is configured to allow access to the plurality of AEAs to operate within the software framework based on a set of rules and/or security protocols. Similarly, the software framework may deny access to the plurality of AEAs to operate within the software framework upon determining that the plurality of AEAs do not comply with the set of rules and/or security protocols. In one example, the software framework is implemented by the plurality of AEAs that are configured to enable communication between other AEAs within the software framework, process information associated with an interaction between other AEAs within the software framework, provide (or deny) access to the plurality of AEAs to the software framework and so forth. Moreover, the software framework enables to provide a decentralized economic market for enabling various services to be provided and/or procured by the plurality of AEAs. Such a decentralized economic market may be representative of a real-world environment, such as a real-world market where one or more services are provided and/or procured by the AEAs.

Moreover, optionally, a distributed ledger arrangement is consensually shared and synchronised in a decentralised form across the plurality of worker nodes. The distributed ledger arrangement refers to a database of entries or blocks of data.

In an example embodiment, the service requests provided by the plurality of AEAs is a collective bid provided by multiple AEAs, wherein the multiple AEAs collectively provide the service to the plurality of computing devices. It will be appreciated that a given AEA may only be capable to execute a portion of the service request that is generated by the plurality of computing devices. The service request may include a plurality of steps.

The term “collective bid” as used herein refers to a bid that is generated and communicated by the given AEA to the plurality of computing devices, wherein the given AEA acts on behalf of multiple AEAs, and wherein the multiple AEAs collectively provide the service to the plurality of computing devices. In such an instance, the given AEA may simultaneously be a client AEA, namely a secondary client AEA, that may be acquiring services from one or more other AEA, namely a second plurality of AEAs for the execution of the remaining portion of the service.

Beneficially, such a system for managing services provides the user with an optimized management of resources, that is capable of saving energy, saving resources, saving wear-and-tear, enhancing reliability of service delivery, and so forth. The system allows for maximizing utilization of resources and maximize value for each of the parties involved, namely the client and the service providers by reducing idle time in a way that a centralized or human mediated system could not. Such a system where the plurality of AEAs collaborate amongst themselves to provide the collective bid for the service request allows for better utilization of resources for the service providers who are only capable of executing a segment/part of the requested service. Moreover, such a system also increases availability of options for seeking a service by the user as the system is able to take into consideration collective bids wherein multiple service provider autonomous economic agents collectively provide the service to the client. Such a system is especially effective when no single service provider is able to bid in response to the service request generated by the client AEA.

Optionally, at least one service bid (offer made by a service provider) of the plurality of service bids is a collaborative service bid associated with two or more autonomous economic agents. In an example, the service bid for the aforesaid service request for transporting the user from Birmingham to Amsterdam may include at least two service providers such as travel agents. In such example, one service provider may be from Birmingham and the other service provider may be from Amsterdam. In such example, the service provider from Birmingham may provide service based on the rules and norms of the United Kingdom and the service provider from Amsterdam may provide service based on the rules and norms of the Netherlands. Therefore, the service bid generated by the service providers may include the rules and norms of United Kingdom and Netherlands. In such instance the autonomous economic agents associated with the service components of the service provider from Birmingham may communicate with the autonomous economic agents of the service components of the service provider from Amsterdam. Furthermore, the autonomous economic agents are operable to determine the travel route of the user that is safe, fast, and cost-effective. Optionally, the service provider may collaborate with another service provider including the service component to complete the service request such as the request for surveying the area using a drone having specific sensors generated by the user.

In an embodiment, the service request includes at least one of a time needed for providing the service, a price associated with the service, a quality associated with the service, and/or at least one preference associated with the service. For example, the user specifies a parameter (such as, using the graphical user interface associated with a client device) including at least one of the time, the price, the quality and/or at least one preference that is required by the user in the provided service. In such an instance, the parameter is provided to the client AEA with the generated service request. Furthermore, the client AEA is configured, namely operable, to use the parameter to provide the maximum value to the user. In one example, the service request includes the price associated with the service, such as a minimum and maximum price associated with the service. In such instance, the client AEA enables the user to obtain the service at a price within the minimum and maximum prices specified by the user. Preferably, the client AEA enables the user to obtain the service associated with the minimum price, thereby, enabling maximum value to be provided to the user. In another example, the service request includes a preference associated with the service, such as, to obtain an eco-friendly service. In such an instance, the client AEA enables the user to obtain the service from a service provider that utilizes eco-friendly sources of energy (and/or materials) for providing the service.

The software framework includes the domain-independent protocol specification language. The term “domain-independent protocol specification language” as used herein refers to a formal language that enables the definition of protocols for interactions across the plurality of problem domains. In this regard, the domain-independent protocol specification language is used to describe the format, structure, and rules for communication between the plurality of AEAs and between the plurality of AEAs and the plurality of computing devices associated with the decentralized computing network, regardless of the specific application domain or context. It will be appreciated that the domain-independent protocol specification language provides a standardized way of defining protocols that enables interoperability and seamless communication among the plurality of AEAs in the system, regardless of the domain thereof. Moreover, the domain-independent protocol specification language in the open economic framework promotes fairness, transparency, and efficiency in the system. Furthermore, the domain-independent protocol specification language enables the system to become scalable for providing multi domain services.

Optionally, the domain-independent protocol specification language is stored in a form of a set of instructions, in at least one memory device of the decentralized computing network. In this regard, the domain-independent protocol specification language is stored on the at least one memory device in a manner that makes it easily accessible to the plurality of AEAs. Optionally, the at least one memory device may be a physical memory device, such as a hard drive or a flash drive, or a virtual memory device, such as a cloud-based server. Optionally, the domain-independent protocol specification language could also be stored on a cloud based memory. Optionally, the cloud based memory is communicably coupled to the decentralized computing network. Furthermore, storing the domain-independent protocol specification language in the form of the set of instructions promotes interoperability, standardization, and reliability in the decentralized computing network, and supports the smooth functioning thereof. It will be appreciated that said set of instructions is well defined and thus could be easily used for defining various types of protocols.

The software framework includes a protocol generator. The term “protocol generator” as used herein refers to a software tool that generates protocol(s) for AEAs using the domain-independent protocol specification language. The term “protocol” as used herein refers to an implementation of the rules and guidelines described in a protocol specification. In other words, the at least one protocol is one of the critical building blocks and abstractions that define communications of the given AEA. The at least one protocol of the given AEA defines interactions of the given AEA with other AEAs amongst the plurality of AEAs, and with the plurality of computing devices. Moreover, the at least one protocol defines how messages are encoded for a transportation thereof. Optionally, the at least one protocol includes constraints or conditions to ensure that a certain message sequence follows a specific pattern. For example, a “SELL” message must follow a “BUY” message, and a “FINISH” message must follow a “START” message. This means that the given AEA will only be able to “SELL” or “FINISH” if the appropriate preceding message (BUY or START) has been sent. Additionally, such constraints help to maintain the consistency and integrity of the communication between the plurality of AEAs. It will be appreciated that the protocol generator enables streamlining a development process of the given AEA, reduces the risk of errors in the interactions of the given AEA, and ensures that the at least one protocol is consistent and well-defined. Optionally, the at least one protocol pertains to interactions of the given AEA across the plurality of problem domains. In this regard, the domain-independent specification language enables the definition of protocols for interactions across the plurality of problem domains. This means that in such a case any protocol could enable the given AEA to interact for addressing the service requests from the plurality of problem domains.

The at least one software module is configured to receive, from the given AEA, the invocation of the protocol generator for the protocol specification. The term “protocol specification” as used herein refers to a set of rules and guidelines that defines a communication between the plurality of AEAs in the decentralized computing network. The protocol specification is a formal manner in which the at least one protocol is defined. The protocol specification may outline the types of information that may be exchanged between the plurality of AEAs and the format in which the information should be transmitted. Optionally, the protocol specification may also define a timing of when the information should be exchanged and any error-handling mechanisms that should be in place. The at least one software module could be a given AEA. For example, an AEA, which is a software module, could itself implement the step of execution of the protocol generator. The at least one software module could be a software module part of the software framework without being associated with an AEA.

In an example, when the plurality of computing devices of the decentralized computing network interact with the at least one software module for performing the one or more tasks, the given AEA invokes the protocol generator for the protocol specification. In another example, the given AEA may invoke the protocol generator for the protocol specification at one or more pre specified time instance. In yet another example, the given AEA may invoke the protocol generator for the protocol specification when any of the given AEA's modular components changes.

In an example, the protocol specification in the mobility domain is a set of rules and guidelines that define the interaction between two AEAs attached to two different autonomous vehicles when exchanging real-time traffic information. Optionally, the protocol specification would likely outline the specific types of information that can be exchanged between the AEAs, such as traffic congestion levels, accident reports, road closures, and construction updates.

The at least one software module is configured to execute the protocol generator to produce the implementation of the at least one protocol corresponding to the protocol specification, for the given AEA, using the domain-independent protocol specification language, and by taking into account the technological setup of the given AEA. Herein, the implementation of the at least one protocol refers to a combination of code, data structures, and algorithms that defines how the given AEA communicates with other AEAs and the plurality of computing devices, process incoming service requests, and execute specific actions based on the protocol specification defined in the at least one protocol. Optionally, the implementation is a working version of the at least one protocol that can be integrated into the given AEA and put into operation. In other words, the implementation of the at least one protocol is the outcome of the process of creating the code or configuration files that follow the rules and conventions defined by the protocol specification, taking into account the specific technology setup of the agent that is going to use it.

The “technological setup” of the given AEA refers to specific technologies and resources that are available to the given AEA within the system. Optionally, the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on. In this regard, the domain-independent specification language is received by the protocol generator to produce the concrete implementation of the protocol for the given AEA invoking the protocol generator. Moreover, the domain-independent protocol specification language is also independent of the technological setup of the given AEA. The technological set up includes the programming languages used by the given AEA. Examples of the programming language include Python, Java, C++, and so forth. The technological set up includes the operating system of the given AEA. Examples of the operating system include Windows, MacOS, Linux, and so forth. The technological set up includes the library available to the given AEA. Examples of the library TensorFlow, NumPy, OpenCV, and so forth. The technological set up includes the amount of computational resources available with the given AEA. Examples of the computational resources include a processor type, a random access memory, a storage device, and so forth. The technological set up includes the platform that the given AEA runs on. Examples of the platform includes Cloud, Edge, Mainframe, and so forth. It will be appreciated that the technological setup may be used in some implementations to determine how the at least one protocol should be implemented for the given AEA. For example, if the technological setup of the given AEA includes a limited amount of memory, the protocol generator may produce an implementation of the protocol that is optimized for low-memory usage. In another example, if the agent's technological setup includes support for a specific programming language, the protocol generator may produce an implementation of the protocol in that specific programming language.

In this regard, the protocol generator receives the protocol specification as an input and produces the concrete implementation of the protocol as an output for the given AEA invoking it. The concrete implementation takes into consideration the technology set up of the given AEA. In an example, the system comprises two AEAs such as an agent A and an agent B. The agent A is running on a Raspberry Pi 4 (with its typical standard system specification) with “Raspberry Pi OS”, a Unix-like operating system, running a version of the AEA framework that is written in the C++ programming language. The agent B is running on the cloud infrastructure, with Windows operating system, and access to 48 virtual CPUs and 512 GB of memory, running a version of the AEA framework that is written in the Python programming language. Herein, upon invocation of the protocol generator by the agent A with respect to the given protocol specification, the protocol generator produces the implementation of the at least one protocol in C++. Upon invocation of the protocol generator by the agent B, the protocol generator produces the implementation of the at least one protocol in Python.

Optionally, the at least one protocol implemented by the protocol generator enables the given AEA to interact in mixed cooperative and adversarial environments, across the plurality of problem domains. In this regard, the mixed cooperative and adversarial environment is a situation where the plurality of AEAs interact with each other in a way that involves both cooperation and competition. In the cooperative environment the plurality of AEAs may be required to work together for fulfilling the service request. In such a cooperative environment, the plurality of AEAs may have incentives to work together for mutual benefit. For example, in a digital marketplace, some AEAs may cooperate by sharing information and setting prices together to increase sales, while other AEAs may choose to compete (in an adversarial manner) by undercutting prices to gain market share. In a financial market, some AEAs may choose to cooperate by sharing information and forming trading alliances, while other AEAs may choose to act independently and try to outsmart their competitors. In a mixed cooperative and adversarial environment, the at least one protocols are well-defined to enable interaction in a predictable and fair manner, thereby enabling the plurality of AEAs to achieve their goals.

Optionally, the implementation of the at least one protocol for the given AEA is produced as a protocol package comprising a logic associated with the protocol specification and a validation check on syntax and semantics of at least one service request message that is sent and/or received by the given AEA. The term “protocol package” as used herein refers to a software package that defines interaction between the plurality of AEAs and between the plurality of AEAs and the plurality of computing devices. In this regard, the protocol generator generates the protocol package for the given AEA after taking into consideration the technological setup thereof. This allows the plurality of AEAs to communicate and interact effectively according to the protocol specification, regardless of the technological setups thereof. The protocol package optionally includes the logic associated with the protocol specification. Optionally, the logic may be an algorithm that governs the communication of the given AEA in a specific economic environment. For example, the logic may dictate how the given AEA should handle orders, execute trades, and manage funds thereof. In another example, in order to receive an order from a user, the logic may include receiving a request to buy or sell a specific token by the given AEA. In yet another example, in order to broadcast trade details, the logic may include broadcasting to the network the details of the trade, such as a price, a quantity, and tokens involved, to keep a public record of all the trades.

The protocol package optionally includes the validation check on syntax and semantics of at least one service request message that is sent and/or received by the given AEA. Moreover, each programming language has a different syntax, so validation checks are also done while producing the implementation of the protocol by protocol generator. The validation check ensures that the at least one service request message sent or received by the AEA complies with the syntax and semantics defined in the protocol specification. This ensures that the at least one service request message is processed accurately. It will be appreciated that the validation check enables prevention of any potential errors or misunderstandings in communication between the plurality of AEAs and between the plurality of AEAs and plurality of computing devices. Examples of the validation checks that could be performed in the protocol package includes a message syntax validation check, a data type validation check, a semantic validation check, a signature validation check, and so forth. The message syntax validation check verifies that the structure of the at least one service request message, such as its format, length, and fields, is correct and follows the defined syntax in the protocol specification. The data type validation check ensures that the data in the at least one service request message is of the correct type, such as a number, string, or boolean, as specified in the protocol specification. The semantic validation check ensures that the meaning of the data in the at least one service request message is correct and follows the semantics defined in the protocol specification. For example, checking that a trade request message has the correct token symbols and trade quantity. The signature validation check verifies the authenticity of the at least one service request message by checking the digital signature attached thereto. This ensures that the at least one service request message was indeed sent by the given AEA it claims to be from and has not been tampered with during transit.

The at least one software module is configured to combine at least one of: one or more protocols for at least one AEA, one or more skills of at least one AEA, one or more connections supported by at least one AEA, in the plurality of manners, to create the plurality of AEA-based functionalities for the given AEA across the plurality of problem domains. In this regard, the given AEA is developed in a manner that it is composed of at least one of: the one or more protocols (for a single AEA or for multiple AEAs), the one or more skills (of a single AEA or of multiple AEAs), the one or more connections (supported by a single AEA or supported by multiple AEAs). It will be appreciated that the at least one AEA whose protocols are used in such combining may be different from the at least one AEA whose skills are used in such combining and from the at least one AEA whose connections are used in such combining. In an example, the software framework is associated with ten AEAs Z1 to Z10. For a given AEA Z2 there may be combined a total of four protocols for AEAs Z1 and Z3, a total of three skills of AEAs Z1, Z4 and Z5, and a total of two connections supported by Z1.

The term “skills” as used herein refers to specialized software modules that provides various capabilities to the plurality of AEAs. In other words, the skills are behavioral capabilities of the plurality of AEAs that enables the plurality of AEAs to fulfil the service requests (for example in the plurality of problem domains). Examples of the one or more skills include, but are not limited to, determining a real-time data on the one or more connections, buying or selling an item, price negotiation, and data retrieval. Optionally, the given AEA autonomously acquires new skills, either through direct acquisition of software modules or by shared learning. For example, if the given AEA has a goal to acquire concert tickets at a cheapest price and already has a required negotiation skill, the given AEA may search for sellers, and on encountering another AEA selling said tickets via an auction, the given AEA would then autonomously acquire the necessary negotiating skill from another experienced AEA. The term “connections” as used herein refers to at least one of: a connection between the given AEA and another AEA, a connection between the given AEA and a computing device. The computing device could also be a data source that just has data stored thereon, the data source may not necessarily perform computations on the data. Optionally, at least one AEA may run the one or more connections via a multiplexer.

In this regard, the one or more protocols, the one or more skills and the one or more connections are building blocks or core elements of the given AEA that define the decision-making process and functionality thereof. The software framework may possess a dedicated module for combining at least one of: the one or more protocols, the one or more skills, the one or more connections in the plurality of manners. Herein, combining encompasses at least aggregating the one or more protocols for the given AEA, one or more skills of the given AEA, the one or more connections supported by the given AEA. Optionally, the aggregating is performed by using an aggregator module. Optionally, the aggregator module is a feed reader that when enabled could fetch syndicated content from other by one or more computing devices. The aggregator module can comprise one or more aggregator sub-modules, wherein each aggregator sub-module aggregates sub-services provided by one or more computing devices.

Optionally, when combining the one or more protocols for the at least one AEA, the one or more skills of the at least one AEA, and the one or more connections supported by the at least one AEA in the plurality of manners, for each manner of combination amongst the plurality of manners, the at least one software module in operation adds a logic that is exclusive to the manner of combination. In this regard, the given AEA is modular such that at least one of: the one or more skills (behaviors), one or more protocols (communication), the one or more connections (relationship with external data sources, computing devices, and similar) could be combined together in different ways to create new functionalities. The modularity enables re-use of existing components to further accelerate the development process.

Herein, the logic refers to a custom set of rules or instructions that are exclusive or specific to create a particular AEA-based functionality for the given AEA. It will be appreciated that the exclusive logic is intended to optimize and customize the given AEA for the specific combination being used. Moreover, the exclusive logic makes the given AEA more efficient and effective in performing the one or more tasks and achieving an objective thereof.

In an example, a skill A encapsulating a simple logic of looking up real-time data on external data sources, and a skill B that places a buy/sell order on an item in an online marketplace, could be combined together in a skill C to look up the price of a certain goods (using skill A), and place a buy/sell order on a specific marketplace (using skill B) if the price changes more than a certain threshold (logic exclusive to skill C).

Optionally, the at least one software module in operation further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

In this regard, the at least one software module in operation optionally allows for easier updates and maintenance of the functionalities of the given AEA by performing such swapping. Furthermore, this modularity and reusability coupled with the ability to generate protocols from domain-independent specification language, not only accelerates the development process but also the application of AEAs in new problem domains making them future-proof.

Optionally, for agent-based application with complex functionality in the plurality of problem domains, the existing components such as at least one of: the one or more protocols, the one or more skills, the one or more connections could be reused, or new components could be added depending upon the required functionality and part of service that can be offered by the existing components. Such optional addition of new components extends the functionalities of the given AEA. Optionally, the other component that could be reused is a smart contract that defines the interaction with a blockchain network.

The at least one software module in operation optionally allows for removal of at least one of the given skill, the given protocol, the given connection that is no longer required. It will be appreciated that such removal makes the given AEA light weight and also allows for greater flexibility and adaptability of the given AEA. Optionally, the at least one software module could make said adjustments dynamically, adapting to the requirements of a given situation. Additionally, the system ensures that the given AEA remains efficient and effective, even as new skills, protocols, and connections are developed and existing ones become obsolete or are swapped.

Optionally, the at least one software module may use a tool such as an open economic ledger that is configured to record the progress of the process for providing the service to the user by monitoring the exchange of data between a first AEA and a second AEA. In an example, let us say that the progress of the process of providing service to the user is in a step where the service is being executed by the second AEA using the plurality of service components and two of three service components have done their work. So, the OEL will be updated by the second AEA about the status of the service being provided. More optionally, the first AEA is configured to acquire the data associated with the progress of the service and provide the acquired data to the user.

Optionally, the implementation of the at least one protocol for the given AEA defines at least one dialogue-based bilateral interaction protocol supporting arbitrary agent-based interactions of the given AEA. In this regard, the implementation of the at least one protocol for the given AEA enables the given AEA to engage in bilateral interactions with the plurality of AEAs in a defined and structured manner. The term “dialogue-based bilateral interaction protocol” refers to a set of rules and procedures that govern the communication and exchange of information by AEAs in a conversational or a dialogue-based manner. It will be appreciated that such dialogue-based bilateral interaction protocol emulates the human to human communication, thereby enhancing the capabilities of the system. Herein, the at least one protocol allows for arbitrary interactions of the AEAs, meaning that the type and content of the interactions are not restricted or predetermined. For example, one such protocol could be a negotiation protocol, where two AEAs engage in a dialogue to agree on terms for a transaction. Optionally, the at least one protocol may define the steps involved in the negotiation process, such as the exchange of information, the making of offers and counter-offers, and the final agreement. It will be appreciated that the implementation of the dialogue-based bilateral interaction protocol for the given AEA enables the given AEA to engage in flexible and dynamic interactions with the other AEAs and computing devices, allowing for a wide range of economic transactions and activities to take place.

The present disclosure also relates to the method as described above. Various embodiments and variants disclosed above apply mutatis mutandis to the method.

Optionally, the decentralized computing network comprises a plurality of computing devices that are communicably coupled to each other, and wherein each of the plurality of computing devices comprises at least one processor, at least one memory device, and a communication interface.

Optionally, the method further comprises the domain-independent protocol specification language in a form of a set of instructions, in at least one memory device of the decentralized computing network.

Optionally, the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on.

Optionally, the implementation of the at least one protocol for the given AEA is produced as a protocol package comprising a logic associated with the protocol specification and a validation check on syntax and semantics of at least one service request message that is sent and/or received by the given AEA.

Optionally, the step of combining the one or more protocols for the at least one AEA, the one or more skills of the at least one AEA, and the one or more connections supported by the at least one AEA in the plurality of manners comprises, for each manner of combination amongst the plurality of manners, adding a logic that is exclusive to the manner of combination.

Optionally, the at least one software module in operation, further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

Optionally, the software framework is associated with a plurality of AEAs which are communicably interconnected using the decentralized computing network, and wherein the plurality of AEAs serve as a plurality of worker nodes of the decentralized computing network, for collectively fulfilling service requests belonging to the plurality of problem domains.

Optionally, the at least one protocol implemented by the protocol generator enables the given AEA to interact in mixed cooperative and adversarial environments, across the plurality of problem domains.

Optionally, the implementation of the at least one protocol for the given AEA defines at least one dialogue-based bilateral interaction protocol supporting arbitrary agent-based interactions of the given AEA.

### DETAILED DESCRIPTION OF THE DRAWINGS

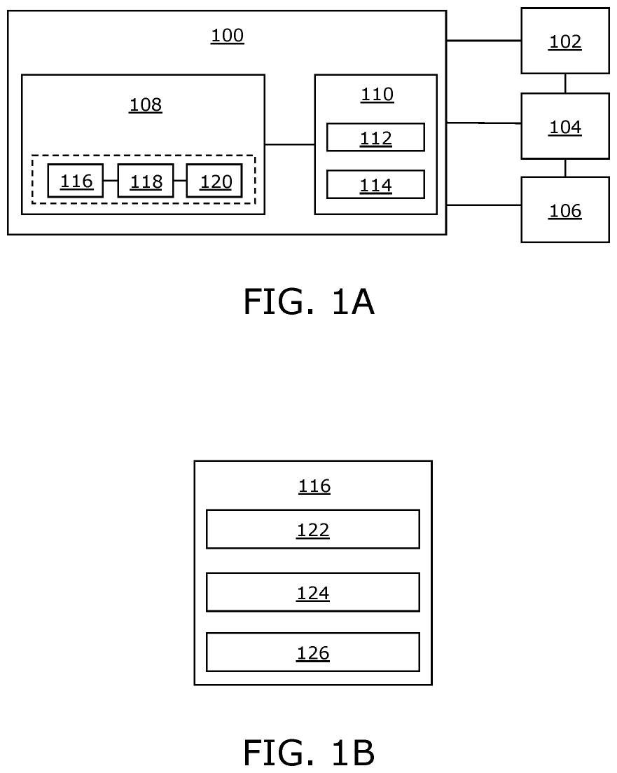

Referring to FIG. 1A, there is shown a block diagram illustrating a system 100 that, in operation, enables accelerated development and application of autonomous economic agents (AEAs) such as 102, 104 and 106, that are modular and extensible, across a plurality of problem domains, in accordance with an embodiment of the present disclosure. As shown, the system 100 comprises a decentralized computing network 108 that is configured to implement a software framework 110, wherein the software framework 110 includes a domain-independent protocol specification language 112, a protocol generator 114 and at least one software module. Moreover, the at least one software module of the software framework 110 receive, from a given AEA (such as the AEAs 102, 104 and 106), an invocation of the protocol generator 114 for a protocol specification (not shown); executes the protocol generator 114 to produce an implementation of at least one protocol corresponding to the protocol specification, for the given AEA, using the domain-independent protocol specification language 112, and by taking into account a technological setup of the given AEA, wherein the at least one protocol pertains to interactions of the given AEA across the plurality of problem domains; and combine at least one of: one or more protocols for at least one AEA such as 102, 104 and 106, one or more skills of at least one AEA such as 102, 104 and 106, one or more connections supported by at least one AEA such as 102, 104 and 106, in a plurality of manners, to create a plurality of AEA-based functionalities for the given AEA such as 102, 104 and 106 across the plurality of problem domains. As shown, the decentralized computing network 108 optionally comprises a plurality of computing devices such as 116, 118 and 120 that are communicably coupled to each other.

Referring to FIG. 1B, there is shown an architecture of a plurality of computing devices (such as the computing devices 116) that are communicably coupled to each other, in accordance with an embodiment of the present disclosure. The computing device 116 comprises at least one processor 122, at least one memory device 124, and a communication interface 126. It will be appreciated that the computing devices 118 and 120 can also have a similar architecture as the computing device 116.

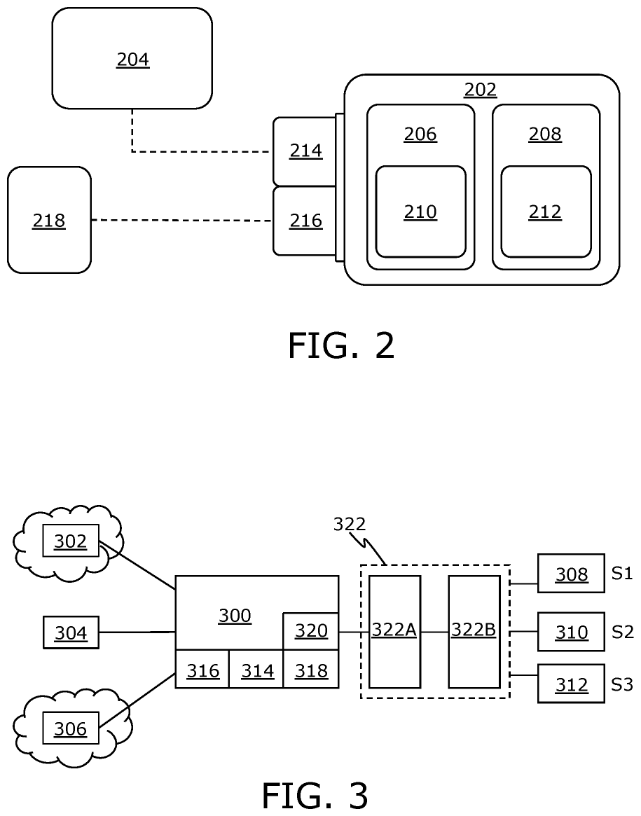

Referring to FIG. 2, shown is a block diagram illustrating abstractions and modularity of a given AEA 202, in accordance with an embodiment of the present disclosure. FIG. 2 also represents another AEA 204 with which the given AEA 202 is capable of interacting. As shown, the given AEA 202 is composed of (i.e., is formed from) one or more protocols (such as protocols 206 and 208), one or more skills (such as skills 210 and 212), and one or more connections (such as connections 214 and 216). Herein, the abstraction also allows for easier updates and maintenance of a behavior of the given AEA 202 by allowing for swapping and/or adding and/or removal of existing/new modular components such as the one or more protocols 206 and 208, the one or more skills 210 and 212 and the one or more connections 214 and 216. Furthermore, the modularity and reusability coupled with the ability to generate the one or more protocols 206 and 208 from domain-independent specification language, not only accelerates the development process but also the application of the given AEA 202 in new problem domains, thus making them future proof. There is also shown a computing device 218 with which the given AEA 202 is capable of interacting via the connection 216. Notably, the given AEA 202 interacts with the another AEA 204 via the connection 214.

Referring to FIG. 3, there is shown a block diagram illustrating an operation of a software framework such as an open economic framework (OEF) 300 for providing a service to a plurality of computing devices such as computing devices 302, 304 and 306, in accordance with an embodiment of the present disclosure. For example, the computing devices 302 and 306 are shown to be cloud-based computing devices. As shown, the plurality of computing devices 302, 304 and 306 are seeking a plurality of services from the OEF 300. Herein, the plurality of computing devices includes a first computing device 302, a second computing device 304 and a third computing device 306. The first computing device 302 is, for example, a cloud server of an organization seeking a first service. The second computing device 304 is, for example, a mobile phone of an end user seeking a second service from the OEF 300. The third computing device 306 is, for example, a decentralized autonomous organization seeking a third service from the OEF 300. Moreover, there is shown a plurality of AEAs such as 308, 310 and 312. There is shown the OEF 300 that includes a protocol generator 314 for receiving a protocol specification and produce a concrete implementation of at least one protocol for a given AEA invoking it, taking into consideration the technological setup of the given AEA. Moreover, the OEF 300 includes other components such as a communication module (such as HTTP) 316, search and discovery (S & D) components 318 to find out the plurality of AEAs 308, 310 and 312 service providers matching the requested service by the plurality of computing devices such as 302, 304 and 306. Furthermore, the OEF 300 includes a registry component 320 that is a database of all the plurality of AEAs 308, 310 and 312 and their components such as skills, protocols and connections corresponding to a given service or the functionality.

There is shown an aggregator module 322 that aggregates sub-services (part of a full service requested by the plurality of computing devices 302, 304 and 306) provided by the plurality of AEAs 308, 310 and 312. The aggregator module 322 can comprise one or more aggregator sub-modules (depicted as sub-modules 322A and 322B), wherein each aggregator sub-module aggregates sub-services provided by one or more computing devices. Moreover, the aggregator module 322 also takes into consideration, a state of the sub-services provided by the plurality of AEAs 308, 310 and 312 and also reaches a consensus for the provided sub-services so as to deliver to the plurality of computing devices 302, 304 and 306, the full requested service. The plurality of AEAs 308, 310 and 312 correspond to (i.e., provide) different services such as services S1, S2, and S3. In this regard, when a new functionality or the service is requested, the plurality of AEAs such as 308, 310 and 312 providing the service or a part of the service could be reused. For example, the first service request could be fulfilled by a combination of the AEA 308 and another AEA 310 providing services S1 and S2, while the second service may be fulfilled by the combination of the AEA 308 and another AEA 312 providing services S1 and S3 depending upon the functionality thereof. Herein, as an example, the service S1 corresponds to transportation, the service S2 corresponds to car washing and the service S3 corresponds to car refuelling. Then if the first computing device 302 requests for car washing service including transportation, then the AEAs 308 and 310 corresponding to S1 and S2 could be selected and reused. In another example if the second computing device 304 requests for car refuelling with transportation, then the AEAs 308 and 312 corresponding to S1 and S3 could be selected and reused.

FIGS. 2 and 3 are merely examples, which should not unduly limit the scope of the claims herein. A person skilled in the art will recognize many variations, alternatives, and modifications of embodiments of the present disclosure.

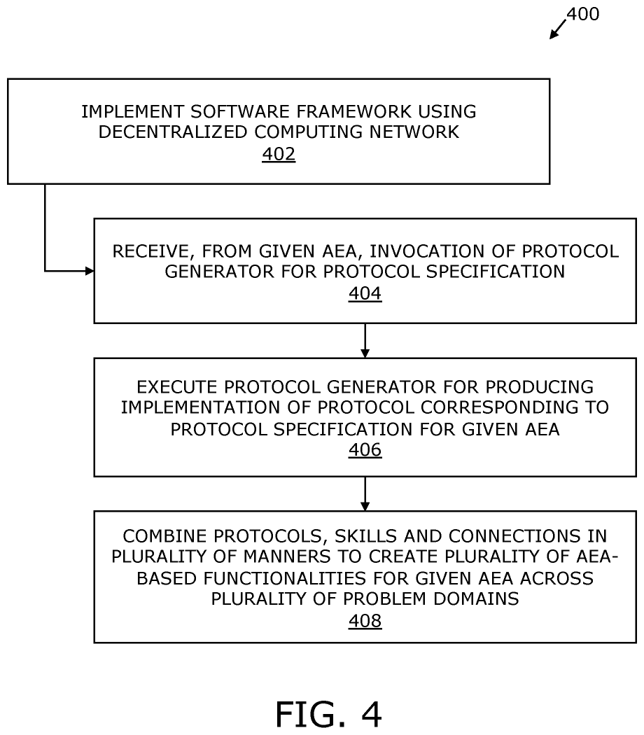

Referring to FIG. 4, shown is a flowchart depicting steps of a method for accelerated development and application of autonomous economic agents (AEAs), that are modular and extensible, across a plurality of problem domains, in accordance with an embodiment of the present disclosure. At step 402, a software framework is implemented using a decentralized computing network, wherein the software framework includes a domain-independent protocol specification language, a protocol generator and at least one software module. Moreover, the at least one software module of the software framework in operation, performs some processing steps that are described below. At step 404, an invocation of a protocol generator for a protocol specification is received by the at least one software module from a given AEA. At step 406, the protocol generator is executed by the at least one software module for producing an implementation of at least one protocol corresponding to the protocol specification, for the given AEA, using the domain-independent protocol specification language, and by taking into account the technological setup of the given AEA. At step 408, one or more protocols for at least one AEA, one or more skills of at least one AEA, and one or more connections supported by at least one AEA are combined by the at least one software module in a plurality of manners to create a plurality of AEA-based functionalities for the given AEA across the plurality of problem domains.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A system that, in operation, enables accelerated development and application of autonomous economic agents (AEAs), that are modular and extensible, across a plurality of problem domains, the system comprising a decentralized computing network that is configured to implement a software framework, wherein the software framework includes a domain-independent protocol specification language, a protocol generator and at least one software module, and wherein:
the at least one software module is configured to receive, from a given AEA, an invocation of the protocol generator for a protocol specification;
the at least one software module is configured to execute the protocol generator to produce an implementation of at least one protocol corresponding to the protocol specification, for the given AEA, using the domain-independent protocol specification language, and by taking into account a technological setup of the given AEA; and
the at least one software module is configured to combine at least one of: one or more protocols for at least one AEA, one or more skills of at least one AEA, one or more connections supported by at least one AEA, in a plurality of manners, to create a plurality of AEA-based functionalities for the given AEA across the plurality of problem domains.

2. The system of claim 1, wherein the decentralized computing network comprises a plurality of computing devices that are communicably coupled to each other, and wherein each of the plurality of computing devices comprises at least one processor, at least one memory device, and a communication interface.

3. The system of claim 1, wherein the domain-independent protocol specification language is stored in a form of a set of instructions, in at least one memory device of the decentralized computing network.

4. The system of claim 1, wherein the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on.

5. The system of claim 1, wherein the implementation of the at least one protocol for the given AEA is produced as a protocol package comprising a logic associated with the protocol specification and a validation check on syntax and semantics of at least one service request message that is sent and/or received by the given AEA.

6. The system of claim 1, wherein when combining the one or more protocols for the at least one AEA, the one or more skills of the at least one AEA, and the one or more connections supported by the at least one AEA in the plurality of manners, for each manner of combination amongst the plurality of manners, the at least one software module in operation adds a logic that is exclusive to the manner of combination.

7. The system of claim 1, wherein the at least one software module in operation further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

8. The system of claim 1, wherein the software framework is associated with a plurality of AEAs which are communicably interconnected using the decentralized computing network, and wherein the plurality of AEAs serve as a plurality of worker nodes of the decentralized computing network, for collectively fulfilling service requests belonging to the plurality of problem domains.

9. The system of claim 1, wherein the at least one protocol implemented by the protocol generator enables the given AEA to interact in mixed cooperative and adversarial environments, across the plurality of problem domains.

10. The system of claim 1, wherein the implementation of the at least one protocol for the given AEA defines at least one dialogue-based bilateral interaction protocol supporting arbitrary agent-based interactions of the given AEA.

11. A method for accelerated development and application of autonomous economic agents (AEAs), that are modular and extensible, across a plurality of problem domains, the method comprising implementing a software framework using a decentralized computing network, wherein the software framework includes a domain-independent protocol specification language, a protocol generator, and at least one software module and wherein the at least one software module of the software framework in operation, performs steps of:
receiving, from a given AEA, an invocation of a protocol generator for a protocol specification;
executing the protocol generator for producing an implementation of at least one protocol corresponding to the protocol specification, for the given AEA, using the domain-independent protocol specification language, and by taking into account the technological setup of the given AEA; and
combining one or more protocols for at least one AEA, one or more skills of at least one AEA, and one or more connections supported by at least one AEA in a plurality of manners to create a plurality of AEA-based functionalities for the given AEA across the plurality of problem domains.

12. The method of claim 11, wherein the decentralized computing network comprises a plurality of computing devices that are communicably coupled to each other, and wherein each of the plurality of computing devices comprises at least one processor, at least one memory device, and a communication interface.

13. The method of claim 11, further comprising storing the domain-independent protocol specification language in a form of a set of instructions, in at least one memory device of the decentralized computing network.

14. The method of claim 11, wherein the domain-independent protocol specification language is at least partially independent of the technological setup of the given AEA, the technological setup of the given AEA comprising at least one of: a programming language in which the given AEA is created, an operating system of the given AEA, a library available to the given AEA, an amount of computational resources available with the given AEA, a platform that the given AEA runs on.

15. The method of claim 11, wherein the implementation of the at least one protocol for the given AEA is produced as a protocol package comprising a logic associated with the protocol specification and a validation check on syntax and semantics of at least one service request message that is sent and/or received by the given AEA.

16. The method of claim 11, wherein the step of combining the one or more protocols for the at least one AEA, the one or more skills of the at least one AEA, and the one or more connections supported by the at least one AEA in the plurality of manners comprises, for each manner of combination amongst the plurality of manners, adding a logic that is exclusive to the manner of combination.

17. The method of claim 11, wherein the at least one software module in operation, further performs at least one of:
in a given manner of combination of the one or more skills, the one or more protocols, and the one or more connections, swapping at least one of: a given skill, a given protocol, a given connection, with at least one of: another skill, another protocol, another connection, respectively;
in a given manner of combination of the one or more skills, the one or more protocols, and the one or more connections, adding at least one of: a new skill, a new protocol, a new connection;
in a given manner of combination of the one or more skills, the one or more protocols, and the one or more connections, removing at least one of: a given skill, a given protocol, a given connection.

18. The method of claim 11, wherein the software framework is associated with a plurality of AEAs which are communicably interconnected using the decentralized computing network, and wherein the plurality of AEAs serve as a plurality of worker nodes of the decentralized computing network, for collectively fulfilling service requests belonging to the plurality of problem domains.

19. The method of claim 11, wherein the at least one protocol implemented by the protocol generator enables the given AEA to interact in mixed cooperative and adversarial environments, across the plurality of problem domains.

20. The method of claim 11, wherein the implementation of the at least one protocol for the given AEA defines at least one dialogue-based bilateral interaction protocol supporting arbitrary agent-based interactions of the given AEA.
